(19) United States
(12) Patent Application Publication
(10) Pub. No.: US 2024/0284509 A1
(43) Pub. Date: Aug. 22, 2024

(54) DYNAMIC CHANNEL SWITCH FOR A TRANSMIT OPPORTUNITY IN WIRELESS NETWORKS

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/584,913

(22) Filed: Feb. 22, 2024

Related U.S. Application Data
(63) Continuation of application No. 63/486,426, filed on Feb. 22, 2023.

(51) Int. Cl. H04W 74/0816; H04L 1/00; H04W 74/08

(52) U.S. Cl. CPC H04W 74/0816; H04L 1/0068; H04W 74/0866

(57) ABSTRACT

A dynamic channel switch for a transmit opportunity in wireless networks is described. In an example, a second wireless device has a transceiver configured to receive on a primary channel from a first device, a channel switch announcement from the first device. The second wireless device has a controller configured to perform a channel switch to a secondary channel at a beginning of a transmit opportunity (TXOP) for remaining frame exchanges within the TXOP in response to the channel switch announcement.

### CROSS-REFERENCE TO RELATED APPLICATIONS

This application is entitled to the benefit of U.S. Provisional Patent Application Ser. No. 63/486,426, filed on Feb. 22, 2023, which is incorporated by reference herein.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). Some applications, for example, video teleconferencing, streaming entertainment, high definition (HD) video surveillance applications, outdoor video sharing applications, etc., require relatively high system throughput. The AP has wider BW capability than the client STAs. The wider BW of AP allow for STA's switching between different channels.

### SUMMARY

Embodiments of a method and apparatus for wireless communications are disclosed. In an embodiment, a wireless communication device includes a transceiver configured to receive on a primary channel from a first device, a channel switch announcement from the first device, and a controller configured to perform a channel switch to a secondary channel at a beginning of a transmit opportunity (TXOP) for remaining frame exchanges within the TXOP in response to the channel switch announcement.

In some embodiments, the dynamic channel puncture that is different from the AP's static channel puncture is not allowed.

In some embodiments, the channel switch announcement includes a puncture announcement of unpunctured 20 MHz channels of the secondary channel, the transceiver configured to switch to the unpunctured 20 MHz channel of the secondary channels.

In some embodiments, an unpunctured 20 MHz channel announced in the Trigger frame will not be punctured in the following frame exchanges of the TXOP and the controller of the second device is configured to decode a basic Trigger frame or frames in DL MU PPDU through the unpunctured 20 MHz channel.

In some embodiments, the puncture announcement comprises an announcement of a dummy primary 20 MHz channel of the secondary channel that is not punctured, and the controller of the second device is configured to decode a basic Trigger frame or frames in DL MU PPDU through the dummy primary 20 MHz channel.

In some embodiments, the unpunctured 20 MHz channel is within the secondary channels.

In some embodiments, the puncture announcement comprises dynamic channel puncture information for punctured 20 MHz channels of the secondary channel.

In some embodiments, the transceiver is configured to receive a control frame that includes the puncture announcement and the channel switch announcement.

In some embodiments, the transceiver is configured to perform a frame exchange with the first device using the unpunctured 20 MHz channel.

In some embodiments, the transceiver is configured to receive a PPDU from the first device or the other devices associated with the first device, including a bandwidth (BW) and the duration information of the intra-BSS TXOP where the duration information is used to update the intra-BSS NAV timer at the second device, to receive an inter-BSS PPDU of an inter-BSS TXOP from a different BSS including a BW and the duration information of the TXOP where the duration information and the BW are used to update the basic NAV Timer, to receive an announcement from the first device to perform a channel switch to the secondary channel(s) at a beginning of a transmit opportunity (TXOP), and wherein the controller is configured to perform a channel switch to the secondary channel(s) if the CCA checking indicates the medium idle where CCA checking includes (1) the PHY CCA within the SIFS after the received soliciting Trigger frame to announce the channel switch and (2) the virtual CCA checking by checking the BW of the basic NAV timer and the remaining time of the OBSS TXOP indicated by the basic NAV timer, and sending a responding PPDU if both the PHY CCA and virtual CCA indicate the switched secondary channel(s).

In some embodiments, the controller of the second device is configured to maintain bandwidth information in the basic NAV timer of the second device.

In some embodiments, when the BW of the inter-BSS PPDU is greater than the BW of basic NAV timer, the controller of second device updates the BW of the basic NAV timer.

In some embodiments, the transceiver is configured to receive a soliciting Trigger frame including a request from the first device to perform a clear channel assessment (CCA) before preforming a frame transmission.

In some embodiments, the transceiver is configured to perform a frame exchange with the first device during the TXOP using the selected NAV timer.

In some embodiments, the remaining frame exchanges cover a primary 20 MHz channel of the primary channel.

In some embodiments, the remaining frame exchanges do not cover a primary 20 MHz channel of the primary channel, the transceiver configured to receive a NAV timer for the primary channel with a duration of the TXOP with the channel switch announcement.

In some embodiments, the transceiver is configured to receive a resource unit (RU) Index for the secondary channel from the first device in the secondary channel after performing the channel switch.

An embodiment includes receiving on a primary channel from a first device, a channel switch announcement from the first device, and performing a channel switch to a secondary channel at a beginning of a transmit opportunity (TXOP) for remaining frame exchanges within the TXOP in response to the channel switch announcement.

In some embodiments, the channel switch announcement includes a puncture announcement of an unpunctured 20 MHz channel in the secondary channel, the method comprising switching to the unpunctured 20 MHz channel of the secondary channel.

An embodiment includes receiving on a primary channel from a first device, a channel switch announcement from the first device, performing a channel switch to a secondary channel at a beginning of a transmit opportunity (TXOP) for remaining frame exchanges within the TXOP in response to the channel switch announcement, receiving a resource unit index on the secondary channel after performing the channel switch, and decoding the resource unit index for frame exchanges in the secondary channel.

Other aspects in accordance with the invention will become apparent from the following detailed description, taken in conjunction with the accompanying drawings, illustrated by way of example of the principles of the invention.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system in accordance with an embodiment of the invention.

FIG. 2 depicts a small wireless network with an AP, a first STA and a second STA suitable for an embodiment of the invention.

FIG. 3 depicts messages for operating a wireless network with a DCS mode and channel assessment in accordance with an embodiment of the invention.

FIG. 4 depicts a small wireless network with an AP and three STAs suitable for an embodiment of the invention.

FIG. 5 depicts messages for operating a wireless network with a DCS mode and medium access recovery in accordance with an embodiment of the invention.

FIG. 6 depicts alternate messages for operating a wireless network with a DCS mode and medium access recovery in accordance with an embodiment of the invention.

FIG. 7 depicts further alternate messages for operating a wireless network with a DCS mode and medium access recovery in accordance with an embodiment of the invention.

FIG. 9 depicts a process flow diagram of a dynamic channel switching method for wireless communication in accordance with an embodiment of the invention.

FIG. 10 depicts a process flow diagram of a dynamic channel switching method with an unpunctured channel for wireless communication in accordance with an embodiment of the invention.

Throughout the description, similar reference numbers may be used to identify similar elements.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Dynamic Channel Switching (DCS) provides more chance for the use of secondary channels when the STAs have low BW capabilities (80 MHz or 160 MHz STAs) than the AP's BW capability (e.g. a 320 MHz AP). In current definitions, a secondary channel is a 20 MHz channel that is not the primary channel. A Basic Service Set (BSS) operating channel that is more than 40 MHz includes one primary channel and multiple secondary channels. DCS is performed on a channel switch schedule per-TXOP basis, and a STA doing a dynamic channel switch does the frame exchanges on secondary channels not covered by the operating BW of the STA in response to other channel measurements, e.g., a Clear Channel Assessment (CCA).

Wi-Fi 7 (IEEE 802.11be) supports 320 MHz transmissions in a new 6 GHz band, which is double the 160 MHz channels of Wi-Fi 6 (IEEE 802.11ax) in the 5 GHz band. A continuous 320 MHz of bandwidth is a substantial increase in bandwidth (BW) for a station (STA) to communicate with an AP. In some instances, a wider BW AP, e.g., a 320 MHz AP, may ask the STAs with narrower BW support, e.g., an 80 MHz STA, to switch its operating channel to a secondary channel for the frame exchanges in a Transmit Opportunity (TXOP). The switch may be for a single TXOP, after which the STA switches back to the primary channel, e.g., the primary 80 MHz channel. Such a DCS may be to different secondary channels of different STAs. For a 320 MHz AP, DCS may be performed to an 80 MHz channel of any of the 80 MHz channels of a secondary 160 MHz channel or a secondary 80 MHz channel for an 80 MHz STA. For a 320 MHz AP, DCS may be performed to the secondary 160 MHz channel for a 160 MHz STA. For an 80 MHz AP, DCS may be performed to any one of the secondary channels for a 20 MHz STA. For a 160 MHz AP, DCS may be performed to any one of the secondary channels for a 20 MHz STA. The other dynamic channel switches for a 160 MHz AP and a 320 MHz AP are also possible.

Preamble puncturing is an optional feature introduced in Wi-Fi 6 that improves spectral efficiency by allowing a Wi-Fi 6 or later AP to transmit through a punctured portion of the total BW of the BSS operating channel if some of the secondary channels are being used by other users or has strong interference from other radio interference sources. Preamble puncturing may be used to cut the interference out of the total BW. While the full BW is not available, the rest of the BW may be used. The puncturing parameters specify the preamble puncturing method to be used by the AP/STA and is available, e.g., for Wi-Fi 7 signals with bandwidths greater than 80 MHz.

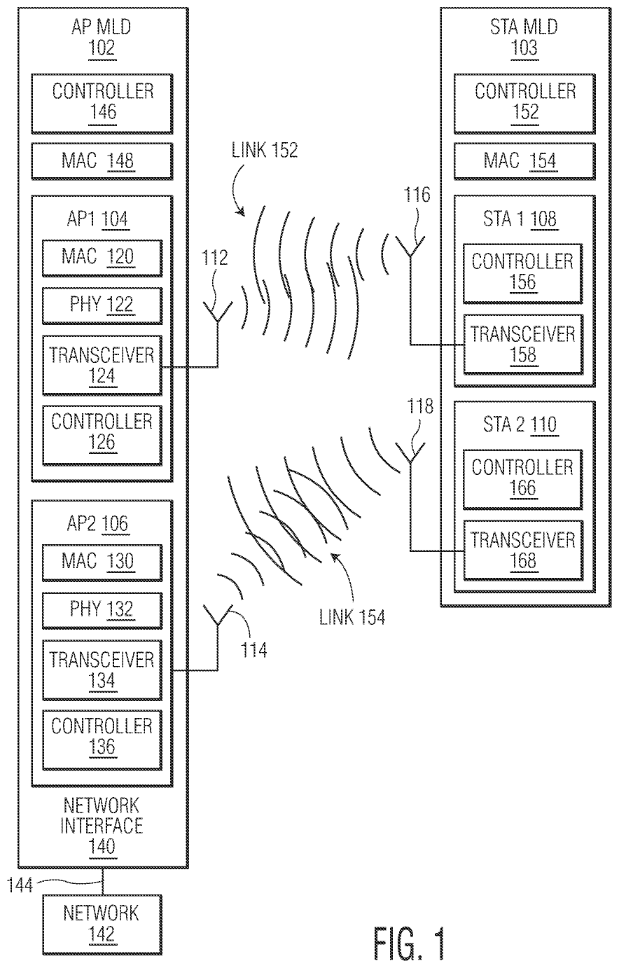

FIG. 1 depicts a multi-link communications system that is used for wireless (e.g., Wi-Fi) communications. In the embodiment depicted in FIG. 1, the multi-link communications system includes one AP multi-link device, which is implemented as AP MLD 102, and one non-AP STA multi-link device, which is implemented as STA MLD (non-AP MLD) 103. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11 protocol. Although the depicted multi-link communications system is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiments, an AP MLD may have a single affiliated AP. In some embodiments, a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 102 includes a controller 146, a network interface 140, a common MAC 148, and two APs 104, 106 in two links 152, 154. In such an embodiment, the APs may be AP1 104 and AP2 106. In some embodiments, a common MAC 148 of the AP MLD 102 implements upper layer Media Access Control (MAC) functionalities (e.g., association establishment, reordering of frames, etc.) and a link specific part of the AP MLD 102, i.e., the APs 104 and 106, implement lower layer MAC functionalities (e.g., backoff, frame transmission, frame reception, etc.) in respective MAC devices 120, 130, PHY layer functionalities in PHY devices 122, 124, and radio functionalities in transceivers 124, 134. The APs 104 and 106 may be implemented in hardware (e.g., circuits), software, firmware, or a combination thereof. The APs 104 and 106 may be fully or partially implemented as an integrated circuit (IC) device. In some embodiments, the APs 104 and 106 may be wireless APs compatible with at least one WLAN communications protocol (e.g., at least one IEEE 802.11 protocol). For example, the APs 104 and 106 may be wireless APs compatible with the IEEE 802.11 protocol.

In some embodiments, an AP MLD (e.g., AP MLD 102) connects to a local area network 142, e.g., a LAN, and/or to a backbone network, e.g., the Internet, through a wired connection 144 and wirelessly connects to wireless STAs, for example, through one or more WLAN communications protocols, such as an IEEE 802.11 protocol. In some embodiments, an AP, e.g., AP1 104 and/or AP2 106, includes multiple RF chains. In some embodiments, an AP, e.g., AP1 104 and/or AP2 106, includes at least one antenna 112, 114, at least one transceiver 124, 134 operably connected to the at least one antenna 112, 114, and at least one controller 126, 136 operably connected to the corresponding transceiver 124, 134. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 104 or 106 of the AP MLD 102 with multiple RF chains may operate in a different BSS (Basic Services Set) operating channel (in a different link). For example, AP1 104 may operate in a 320 MHz (BSS operating channel at 6 GHz band and AP2 106 may operate in a 160 MHz BSS operating channel at 5 GHz band. Although the AP MLD 102 is shown in FIG. 1 as including two APs, other embodiments of the AP MLD 102 may include more than two APs, or one AP only.

In the embodiment depicted in FIG. 1, the non-AP STA multi-link device, implemented as STA MLD 103, includes a common MAC 154, two non-AP STAs 108 and 110 in two links. In such an embodiment, the non-AP STAs may be STA1 108 and STA2 110. The STAs 108 and 110 may be implemented in hardware (e.g., circuits), software, firmware, or a combination thereof. The STAs 108 and 110 may be fully or partially implemented as an IC device. In some embodiments, the non-AP STAs 108 and 110 are part of the STA MLD 103, such that the STA MLD may be a communications device that wirelessly connects to a wireless AP MLD. For example, the STA MLD 103 may be implemented in a laptop, a desktop personal computer (PC), a mobile phone, or other communications device that supports at least one WLAN communications protocol. In some embodiments, the non-AP STA MLD 103 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 103 implements common MAC functionalities 154 and the non-AP STAs 108 and 110 implement lower layer MAC data functionalities, PHY functionalities.

In some embodiments, the AP MLD 102 and/or the STA MLD 103 may identify which communication links support multi-link operation during a multi-link operation setup phase and/or exchanges information regarding multi-link capabilities during the multi-link operation setup phase. In some embodiments, each of the non-AP STAs 108 and 110 of the STA MLD 103 in different links may operate in a different frequency band. For example, the non-AP STA1 108 in one link may operate in the 2.4 GHz frequency band and the non-AP STA2 110 in another link may operate in the 5 GHz frequency band. In some embodiments, each STA includes at least one antenna 116, 118, at least one transceiver 158, 168 operably connected to the at least one antenna 115, 118, and at least one controller 156, 166 connected to the corresponding transceiver 158, 168. In some embodiments, at least one transceiver includes a PHY device (not shown). The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 103 communicates with the AP MLD 102 via two communication links, e.g., link 1 152 and link 2 154. For example, each of the non-AP STAs 108 or 110 communicates with an AP 104 or 106 via corresponding communication links 152 or 154. In an embodiment, a communication link (e.g., link 1 152 or link 2 154) may include a BSS operating channel established by an AP (e.g., AP1 104 or AP2 106) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 103 is shown in FIG. 1 as including two non-AP STAs, other embodiments of the STA MLD 103 may include one non-AP STA or more than two non-AP STAs. In addition, although the AP MLD 102 communicates (e.g., wirelessly communicates) with the STA MLD 103 via multiple links 152 and 154, in other embodiments, the AP MLD 102 may communicate (e.g., wirelessly communicate) with the STA MLD 103 via more than two communication links or less than two communication links.

Different channel configurations are used to provide a context for switching a STA to another channel. The principles and operations described herein may be applied to other channel configurations. While the principles and operations are described for a primary channel and a secondary channel, there may be third, fourth, fifth, and other channels and the switch may be from a primary to any other channel. Dynamic Channel Switching is used in examples to instruct the STA to switch to another channel, however, the particular structure and format of the channel switch may be adapted to suit different configurations.

### Dynamic Puncture in a Secondary Channel

The AP can dynamically puncture some 20 MHz channels of the BSS Operating Channel. This may be referred to as a Dynamic Channel Puncture (DCP) in that the punctured channels in a TXOP are different from the BSS operating channel and additional static punctured channels announced through the Beacon. DCP is performed by allowing or not allowing channel puncture in any one or more parts of the BSS Operating Channel. In the example of FIG. 5 where the AP announces a 160 MHz BSS operating channel, each channel unit has a 20 MHz bandwidth, so a primary channel (i.e. primary 20 MHz channel) is the second 20 MHz channel and each of the other 20 MHz channels is one secondary channel. The primary 80 MHz channel is the 80 MHz channel (four continuous 20 MHz channels) that cover the primary channel. The secondary 80 MHz channel is the 80 MHz channel (four continuous secondary channels) that does not cover the primary channel. In other examples, once the primary channel is defined, the primary 40 MHz, if it exists, 80 MHz, if it exists, 160 MHz if it exists, channel can be determined, and the secondary 40 MHz, if it exists, 80 MHz, if it exists, 160 MHz, if it exists, channel can be determined.

The AP can dynamically puncture some subset of the secondary channels based on whether the medium is idle or busy. The remaining unpunctured 20 MHz channels may be used for frame exchanges so the unpunctured channels are removed from a dynamic channel puncture announcement. In examples, the primary 20 MHz channel is not punctured to allow the STAs to receive the PPDU from the AP. With such arrangement, the STA can correctly receive the DCP announcements in the control frame or DL MU PPDU.

Whether or not the AP instructs a STA to perform a dynamic channel switch, sometimes referred to as a Dynamic Channel Switch (DCS), the STA decodes the PPDU PHY header's start from the primary channel. From the PHY header of a received PPDU in the primary channel and in the carried Trigger frame if the PPDU is a non-HT duplicated PPDU, the STA is able to determine the PPDU BW and which channels are punctured or not.

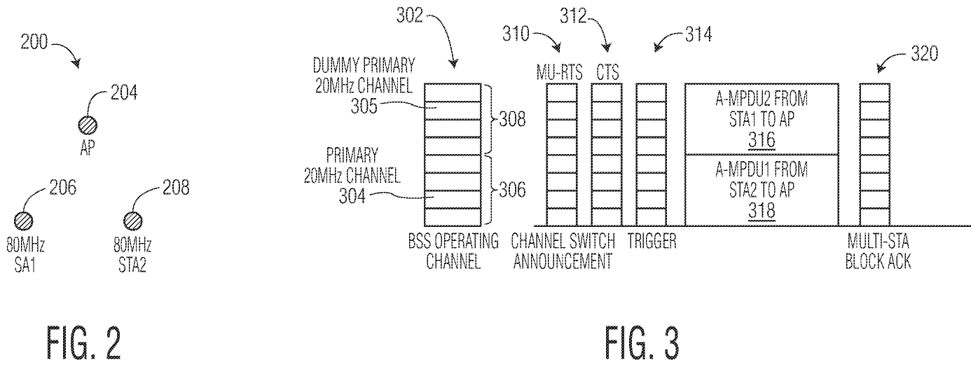

FIG. 2 is a block diagram of a small wireless network 200 with an AP 204, a first STA 206 with an 80 MHz capability and a second STA 208 that has an 80 MHz capability. In this example, as indicated, both STAs operate on the same BSS Operating Channels. The AP may announce a DCS to either a first STA 206 or a second STA 208 and the channel switch to the respective 80 MHz STA (first STA 206 or second STA 208) to switch to the secondary 80 MHz channel.

For a STA, e.g., the first STA 206, to successfully switch to a secondary 80 MHz channel, the channel puncture operation at that secondary channel is defined and announced by the AP to the STA in the primary 20 MHz channel. This allows the STA to follow the puncture pattern, if any. One embodiment is that, in a TXOP, the first STA 206 switches to the secondary 80 MHz channel with dynamic channel puncture, the unpunctured 20 MHz channel at least for the first STA 206 will not be punctured in the following frame exchanges of the TXOP.

FIG. 3 depicts messages for operating a wireless network with a DCS mode and channel assessment. A horizontal timeline proceeds from left to right with earlier transmissions on the left. The vertical extent of each transmission indicates the number of channels being used, e.g., 20 MHz channels. The first block indicates the extent of the Basic Station System (BSS) Operating Channel 302. In this example, the second 20 MHz channel is the primary channel 304 such that the four 20 MHz channels in the 80 MHz channel 306 is the primary 80 MHz channel and the four 20 MHz channels 308 is the secondary 80 MHz channel. Any other number of channels may be used. The primary 20 MHz channel may be assigned to another position to suit particular configurations.

This example pertains to UHR (Ultra High Reliability) in which there is an MU-RTS 310 (Multi-User Request to Send), then a CTS 312 (Clear to Send) in response, then a trigger 314, and A-MPDU 316, 318 (Aggregated MAC Protocol Data Unit) in UHR TB PPDU. A successful A-MPDU is answered with a BA 320 (Block Acknowledgement), e.g., a Multi-STA BA.

The sequence of FIG. 3 begins with an MU-RTS 310 (or a Trigger frame) with the dynamic channel switch information for the addressed STA(s) transmitted by the AP 204 to multiple users, including the first STA 206 and the second STA 208. In this example, the MU-RTS 310 is carried in a non-HT duplicate PPDU by using four 20 MHz channels of the primary channel 306 and four 20 MHz channels of the secondary channel 308, each indicated by the four blocks of each channel. The AP may accommodate the STAs to allow the STAs to switch from the primary channel to the secondary channels that are not covered by the operating BW of the STAs and vice versa depending on the radio environment and strength of other STAs and interferers.

The first STA 206 and the second STA 208 are listening in the primary channel 304 i.e., the primary 20 MHz channel 304. The MU-RTS 310 in the primary 80 MHz channel 306 and secondary 80 MHz channel 308 announces a channel switch for the first STA 206 at the beginning of the subsequent TXOP. After receiving the MU-RTS, the first STA 206 switches to the secondary 80 MHz channel 308 for better medium usage efficiency and replies to the AP after it finishes the switch at the end of the MU-RTS with a CTS 312 in the secondary 80 MHz channel. The characteristics of the secondary channel, including BW and the channel puncture to switch are provided to the first STA 206 in the MU-RTS 310, e.g. by using an RU Allocation field.

The second STA 208 does not receive a channel switch announcement from the AP 204 in this example, so the second STA 208 does not switch to any other channel that is not covered by the BW of the second STA 208. The second STA also answers the MU-RTS 310 but in the primary 80 MHz channel 306 which it still uses.

The STA 208 responds to the MU-RTS 206 with the CTS 208 in the secondary 80 MHz channel 308. The first STA 206 and the second STA 208 are TXOP responders to the AP 202 in this example. When the AP sends the MU-RTS 310 as a non-HT duplicate PPDU, the MU-RTS 310 may be received on multiple 20 MHz channels. After MU-RTS from the AP, the first STA 206 has switched to the secondary 80 MHz channel 308. After the trigger frame 314 from the AP, the STA sends an A-MPDU 316 to the AP 202 on the secondary 80 MHz channel. The second STA 208 has not switched channels and sends an A-MPDU 318 to the AP 202 on the primary 80 MHz channel.

In one example, dynamic channel puncture is not allowed under dynamic channel switch operation. As an example, dynamic channel puncture in the secondary channel 308 (e.g. the secondary 80 MHz channel, the third 80 MHz channel in the secondary 160 MHz channel, the fourth 80 MHz channel in the secondary 160 MHz channel, and the secondary 160 MHz channel) is not allowed.

When a STA 206 switches to a secondary 80 MHz channel 308, the STA can use any 20 MHz channel in the secondary 80 MHz channel that is not punctured through static puncture to decode the basic Trigger frame 314 in a non-HT (High Throughput) Duplicate PPDU, or an UHR DL (DownLink) MU (Multi-User) PPDU.

In a second example, in each group of secondary 20 MHz channels, a dummy primary 20 MHz channel 305 that is one of the secondary channels is assigned as an unpunctured 20 MHz channel under dynamic channel switch operation. Any dynamic channel puncture under dynamic channel switch operation will not puncture the dummy primary 20 MHz channel. The dummy primary 20 MHz channel may be announced by the AP in a Beacon frame or in another management frame.

When a STA 206 switches to a secondary channel 308 and the AP does the dynamic channel puncture for transmitting the basic Trigger frame 314, the STA 206 can use the dummy primary 20 MHz channel 305 to decode the basic Trigger frame 314 in a non-HT Duplicate PPDU, or an UHR DL MU PPDU.

In a third example, dynamic channel puncture is allowed in the first frame exchange for a channel switch announcement in a TXOP. The unpunctured 20 MHz channels in the first frame exchange will not be further punctured in the following frame exchanges in the TXOP. After the first frame exchange, the DCP (Dynamic Channel Puncture) is set for the duration of the TXOP. In a first frame exchange one or more unpunctured 20 MHz channels are designated. In the next frame exchange no changes are made to which channels are punctured. The STA that switches to the secondary channel(s) being not covered by the STA's operating BW starts the decoding operation of the PPDU using any one of the unpunctured 20 MHz channels that the STA switches to. The decoded PPDU can be UHR DL MU PPDU or non-HT duplicate PPDU.

### Clear Channel Access at a Secondary Channel

The controller of the second device, e.g., the first STA 306 is configured to maintain the basic NAV timer (i.e., the inter-BSS NAV timer) with the BW information of the neighbor BSS's, e.g., an Overlapping BSS (OBSS), TXOP and the remaining time of the neighbor BSS's TXOP. When the second device receives an inter-BSS PPDU and the duration information of the PPDU in the PHY header or the MAC header of the PPDU is greater than the remaining time of the second device's basic NAV timer, the controller of the second device updates the basic NAV timer per the received duration information. When the second device receives an inter-BSS PPDU and the BW of the PPDU is wider than the BW of the second device's basic NAV timer, the controller of the second device selects the BW of the inter-BSS PPDU to update the basic NAV timer of the second device (i.e. the inter-BSS NAV timer). When the second device receives an inter-BSS PPDU and the BW of the PPDU is not wider than the BW of the second device's basic NAV timer, the controller of the second device does not select the BW of the inter-BSS PPDU to update the basic NAV timer of the second device (i.e. the inter-BSS NAV timer).

In DCS, if a STA (e.g. the first STA 206) receives the MU-RTS (or Buffer Status Report (BSRP) Trigger) that requests that the STA perform a DCS (e.g. switch to secondary 80 MHz channel 308), the STA decides whether it does the DCS and sends the responding frame based on virtual carrier sensing and PHY carrier sensing on the requested secondary channels for the channel switch (e.g. sensing on the secondary 80 MHz channel 308 by the first STA 206). When the basic NAV timer of the STA indicates a non-zero TXOP duration of an Overlapping BSS (OBSS) TXOP and the BW of the OBSS TXOP covers the requested secondary channels that the STA (e.g. the first STA 206) switches to, the STA determines a busy state for the requested secondary channels. The busy state is based on the virtual carrier sensing using the basic NAV timer.

When the basic NAV timer of the STA indicates a non-zero TXOP duration of the OBSS TXOP and the BW of the OBSS TXOP does not cover the requested secondary channels that the STA (e.g. the first STA 206) is to switch to, the STA determines an idle state or virtual carrier sensing idle for the requested secondary channels. If the basic NAV timer of the STA indicates a zero TXOP duration of OBSS TXOP, the STA has virtual carrier sensing idle on the switched secondary channels. If the STA receives the MU-RTS (or BSRP Trigger) that requests that the STA perform a DCS to channels with virtual carrier sensing idle, then the STA switches to the requested secondary channels per the AP's request in MU-RTS (or BSRP Trigger frame).

The STA may also perform PHY CCA sensing on the secondary channels within a Short Interframe Space (SIFS) before sending the responding frame. If the PHY CCA sensing also indicates that medium idle state on the requested secondary channels to which the STA is to switch, then the STA sends the responding frame in the requested secondary channels and performs the subsequent frame exchanges for the TXOP with the AP. If the PHY CCA sensing of the STA indicates a medium busy status on the requested secondary channels, then the STA does not send the responding frame in the requested secondary channels and does not do the subsequent frame exchanges with the AP.

If the STA receives an MU-RTS (or BSRP Trigger) that requests that the STA switch to a secondary channel, but the requested secondary channel has virtual carrier sensing busy, based on a NAV timer kept at the STA, then the STA does not switch to the secondary channel per the AP's request in MU-RTS (or BSRP Trigger frame). In the example of FIG. 3, the MU-RTS 310 includes a request to the first STA 206 to perform a DCS to the secondary 80 MHz channel 308. After the first STA 206 receives the MU-RTS 310, the first STA 206 determines whether to switch to the requested secondary 80 MHz channel 308 based on whether it has virtual carrier sensing idle on the requested secondary 80 MHz channel 308. It switches to the requested secondary channel 308 at the end of the PPDU of the MU-RTS since the virtual carrier sensing result on secondary 80 MHz channel 308 is idle.

The first STA 206 will track whether the medium is busy or idle through a PHY CCA within SIFS before transmitting the subsequent CTS 312. The first STA 206 transmits the responding CTS on the secondary 80 MHz channel 308 since it detects the medium idle through a PHY CCA within the SIFS before sending the CTS 312. The second STA 308 did not receive a DCS announcement, so it stays on the primary 80 MHz channel 306. When the NAV timer for the primary channel has the value zero and the PHY CCA within the SIFS before transmitting the CTS 312 indicates a medium idle state, then the second STA 208 can send the CTS 312. After the AP receives the CTS solicited by the MU-RTS, the AP transmits the Trigger 314 to solicit A-MPDUs in UHR TB PPDUs from the first STA and the second STA.

After receiving the Trigger 314, since the first STA 206 detects a medium idle state, e.g. through virtual carrier sensing and PHY CCA, on the requested secondary 80 MHz channel 308, the first STA 206 transmits the A-MPDU 316 on the requested secondary channel 308. After receiving the Trigger 314, since the second STA 208 detects a medium idle state e.g., through virtual carrier sensing and PHY CCA, on the primary 80 MHz channel 306, the second STA 208 transmits the A-MPDU 316 on the primary channel 306.

In an example, a STA that is scheduled to a requested secondary 80 MHz channel 308 in a TXOP ignores the basic NAV timer when the basic NAV timer's BW does not cover the requested secondary 80 Mz channel 308 which means the virtual carrier sensing is idle on the secondary 80 MHz channel 308. This may be stated as when the basic NAV timer's BW is 20, 40, or 80 MHz, the requested secondary channel 308 is not covered by the Basic NAV timer, however when the basic NAV timer's BW is 160 MHz, the requested secondary channel 308 is covered by the Basic NAV timer. Besides using the basic NAV timer for virtual carrier sensing, after receiving the request to perform the DCS, e.g., in a MU-RTS 310, the STA also uses PHY CCA to detect whether the secondary 80 MHz channel (or part of the secondary 80 MHz channel if part of the secondary 80 MHz channel is allocated to the STA) is idle within the SIFS before transmitting the CTS.

### Medium Access Recovery at the Primary Channel

After a per-TXOP dynamic channel switch (DCS) in a TXOP (say TXOP 1 where AP1 is the TXOP holder), some STAs are transmitting and receiving on secondary channels to do the frame exchanges with the AP in the TXOP. It may happen that none of the STAs are using the primary channel which may cause all the STAs including the AP to lose synchronization on the primary channel, e.g., the primary 20 MHz channel. This makes it difficult for the AP (i.e. AP1) to start new frame exchanges on the primary channel after the TXOP (i.e. TXOP 1).

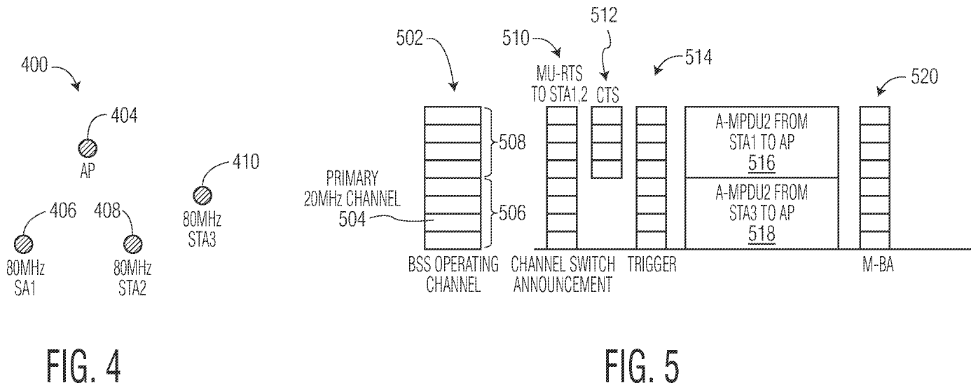

FIG. 4 is a block diagram of a small wireless network 400 with an AP 404, a first STA 406 with an 80 MHz capability, a second STA 408 that has an 80 MHz capability, and a third STA 410 also with an 80 MHz capability. In this example, as indicated, all three STAs operate on the same BSS Operating Channels. The AP may announce a DCS to any one of the STAs so the STA will switch to a different channel, e.g., a secondary channel with or without puncturing and with or without dynamic channel puncture.

FIG. 5 depicts messages for operating the network with DCS mode and medium access recovery. A horizontal timeline proceeds from left to right with earlier transmissions on the left. The vertical extent of each transmission indicates the number of 20 MHz channels being used. The first block indicates the BSS Operating Channel 502 with four 20 MHz channels in a primary 80 MHz channel 506, including a primary 20 MHz channel 504, and four 20 MHz channels in a secondary 80 MHz channel 508. While any suitable frame exchange may be used, in this example, an MU-RTS 510 from the AP 402 covers the primary 80 MHz channel 506 and the primary 20 MHz channel 504 in particular.

In a first example, the AP allows one or more STAs to occupy the primary channel when one or more STAs have switched to secondary channels for frame exchanges. This may be done in different ways. The AP 404 may send a trigger frame 514 in the primary channel 506 to solicit some STAs to transmit an UL TB PPDU in the primary channel. Even if the MU-RTS (or BSRP Trigger) that announces the channel switch does not cause a responding frame to be sent in the primary channel from the solicited second STA 408, then another STA, e.g., the third STA 410, on the primary 80 MHz channel 506 may transmit the solicited A-MPDU or MPDU, e.g., A-MPDU 518, back to the AP 404.

When the AP 404 continues to use the primary channel 506, medium synchronization may be retained through to the end of a TXOP. The AP 404 may maintain synchronization on the primary channel by continuing to transmit over the primary 20 MHz channel 504. The third STA 410 may occupy this primary 20 MHz channel 504 and receive trigger frames 514 that include at least the primary 20 MHz channel 504 and may include the entire primary 80 MHz channel 506. In receiving the trigger frames 514 multiple STAs are able to maintain synchronization on the primary channel.

The MU-RTS 510 includes soliciting the second STA 408 to transmit CTS in the primary 80 MHz channel 506 and a channel switch announcement to the first STA 406 which then switches to the secondary channel 508. The first STA 406 answers with a CTS 512 that covers only the secondary 80 MHz channel 508 and not the primary 80 MHz channel 506. The solicited second STA 408 does not send CTS in primary 80 MHz channel 506 since the second STA 408 detects the medium busy in primary 80 MHz channel. The AP then sends a trigger 514 that covers the primary channel 506 and the secondary channel 508 to be received by the first STA 406 that is in the secondary 80 MHz channel 508 and the third STA 410 in the primary 80 MHz channel 506. This is followed by an A-MPDU 516, 518 from STAs 406, 410. The successful A-MPDU is answered with a BA 520, e.g., a Multi-STA BA.

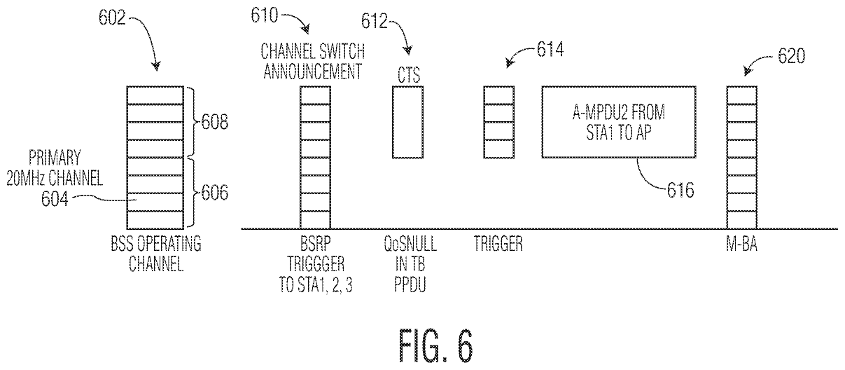

FIG. 6 depicts messages for operating the network with DCS mode and medium access recovery. A horizontal timeline proceeds from left to right with earlier transmissions on the left. The first block indicates the BSS Operating Channel 602 with four 20 MHz channels in a primary 80 MHz channel 506, including a primary channel 504 and three other secondary channels, and four secondary channels in a secondary 80 MHz channel 508, although other configurations may be used. While any suitable frame exchange may be used, in this example a BSRP (Buffer Status Report) trigger 610 is sent from the AP 402 that covers the primary 80 MHz channel 606 and the secondary 80 MHz channel 608. However, the STAs solicited by the BSRP trigger 610 in the primary 80 MHz channel 606 cannot transmit the solicited (Quality of Service) QoS Null frames since those STAs detect that medium busy for the primary 80 MHz channel. A TB PPDU 612 followed by a trigger 614 in the secondary 80 MHz channel 608, followed by an A-MPDU 616 and an M-BA 620 are sent only in the secondary channel 608. In this example, only the BSRP trigger covers the primary channel 606.

In this second example, the AP 402 may transmit only occasionally with no frame exchanges that cover the primary channel 604. The primary channel 606 is protected by the Duration field of the initial frame, e.g., a trigger frame, a BSRP trigger frame 610, etc. The BSRP trigger frame 610 may have a duration parameter that covers an entire TXOP. The AP 402 uses a frame that is not RTS or MU-RTS to let the STA or AP of a neighbor BSS to set the NAV timer. Alternatively, when the initial frame being used for the channel switch announcement is the RTS/MU-RTS 510, the AP 402 transmits the frames in the following frame exchanges to cover just the primary channel 604 in the frame exchange that follows the RTS/CTS exchange (or MU-RTS/CTS exchange).

For a neighbor STA in a neighboring BSS (not shown), its NAV timer is set based on the duration field in the MAC layer of the channel switch frame. The duration covers the subsequent frame exchanges until the end of the TXOP. This prevents a neighbor BSS from occupying the primary 20 MHz channel 604.

In a third example, the AP 402 allows that there are no frame exchanges that cover the primary 20 MHz channel 704. As a result, with no frame that covers the duration of the TXOP, the AP loses synchronization of the medium at the end of the TXOP.

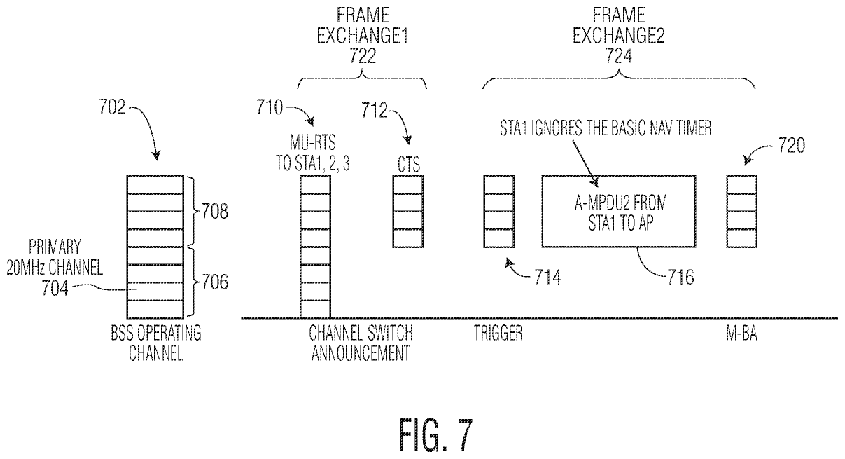

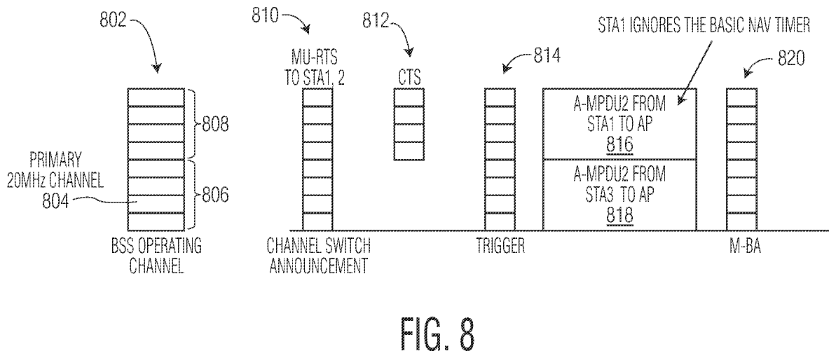

FIG. 7 depicts messages for operating the network with DCS mode and medium access recovery. A first block on a horizontal timeline indicates the BSS Operating Channel 702 with the primary 80 MHz channel 706, including a primary channel 704 and four secondary 20 MHz channels in a secondary 80 MHz channel 708, although other configurations may be used. In this example, a first frame exchange 722 has an MU-RTS 710 from the AP 402 and a CTS 712 on the secondary 80 MHz channel 708 from one or more of the STAs on the network. The STAs being solicited by MU-RTS 710 cannot transmit the responding CTS since they detect medium busy. A second frame exchange 724 has a trigger 714 on the secondary channel 708 an A-MPDU 716, and a M-BA 720 all on the secondary channel 708. In this example, the CTS 712, trigger 714, A-MPDU 716 and M-BA do not cover the primary channel and do not cover the 20 MHz primary channel. As a result, another STA of a neighbor BSS may detect that the primary channel is not in use and may attempt to occupy it.

The AP 402 may recover the primary 20 MHz channel 704 at the end of a TXOP in a few ways. In one example, the AP 402 waits for the duration of a maximal PPDU length. This may be done e.g., by setting a mediumSyncTimer with the maximal PPDU length or with another appropriate value. The AP then performs a backoff and transmits a trigger frame, RTS, MU-RTS, etc.

In another example, the AP waits until the detection of a PPDU, sets a NAV timer, waits for a backoff time, and then transmits a trigger frame, RTS, MU-RTS, etc. In some examples, because there is no response from any STA with a CTS 712 in the primary channel 706 as shown. The AP may send the trigger 714 also in the primary channel. If the trigger has enough power, then other neighboring STAs will receive this signal and not attempt to occupy the primary channel 706.

In another example, when the AP waits for the mediumSyncTimer, if any, to expire, the AP does a CCA by using a higher sensitivity. A standard CCA may have a sensitivity at −80 to −90 dBm, e.g., −84 dBm, so that any signal over −84 dBm is considered to be an interferer using the channel. A higher sensitivity may be to detect a signal at −65 to −75 dBm, e.g., −72 dBm, or another higher level. If the channel is idle and no PPDU has been detected, then the AP may do a backoff and then transmit. The AP may transmit RTS/MU-RTS to STAs in which the operating channel covers the primary 20 MHz channel 704. If a CTS is received that covers the primary 20 MHz channel 704 then the AP waits. After a NAV timer and a backoff, then the AP may try again according to one of the above examples.

### RU Index

When DCS is used, a STA may switch to the secondary channel(s) per the suitable RU Index (Resource Unit Index) for the STA in the channel switch announcement. The first device (the AP) uses the RU Index in the User Info field of the soliciting Trigger frame addressed to the second device (a STA) to indicate the secondary channel(s) that the second device needs to switch to for the frame exchanges in the remaining time of the TXOP. The second device will switch to the indicated secondary channels for the frame exchanges in the remaining time of the TXOP. In one example, the RU Index to the second device is coded in accordance with the BW of the PPDU carrying the soliciting Trigger frame. In one example, the RU Index to the second device supports a BW to do the channel switch in the TXOP and is coded in accordance with the BW of the BW that the second device supports as if the BW covers the primary channel.

FIG. 8 depicts messages for operating the network with DCS mode communicating an RU Index. A first block on a horizontal timeline indicates the BSS Operating Channel 802 with primary 80 MHz channel 806, including a primary 20 MHz channel 804, and four secondary channels in a secondary 80 MHz channel 808, although other configurations may be used. In this example, a first frame exchange has an MU-RTS 810 from the AP 402 and a CTS 812 only on the secondary 80 MHz channel 808 from one or more of the STAs on the network. A second frame exchange has a trigger 814 on the primary 80 MHz channel 806 and on the secondary 80 MHz channel 808. Followed by an A-MPDU 816 on the secondary 80 MHz channel from a first STA and an A-MPDU 818 from the second STA 818 on the primary 80 MHz channel. The frame exchange ends with a M-BA 820 on the full BW of primary 80 MHz channel 806 and secondary 80 MHz channel 808.

The trigger frame 814 may include user info for two or more STAs, e.g. a first user info for STA 1 and a second user info for STA 3. To respond to the trigger with an A-MPDU 816 from STA1 and an A-MPDU from STA3. The RUs allocated to each STA must be provided by the AP. The position of an RU is determined by the RU index. The RU index gives the width and location of the RU, e.g. the frequencies of the RU. The user info has an RU index field, e.g., 996 tones which is for an 80 MHz location will be in a primary AP. For STA 1 RU is 996 tones for an 80 MHz channel and this is indicated is in the secondary channel.

Upon a switch, e.g. announced by the MU-RTS 810 from the primary 80 MH channel 806 to a secondary 80 MHz channel 808, the STA that has switched, e.g. STA1, no longer receives on the primary channel. The AP is not able to send the RU indices to STA 1 on the primary 20 MHz channel.

In a first example, the AP may use a frame different from Trigger frame to announce the channel switch. The AP transmits the RU Index for the secondary X-BW channel to the STA already switched to secondary channels not covered by STA's BW in the same way as for a primary X-BW channel, e.g. 80 MHz subchannel. For a STA that is to perform a DCS on a per TXOP basis as discussed above, the AP transmits the RU index to that STA on the secondary 80 MHz channel that does not indicate the RU is in secondary channel.

Consider an X-BW (e.g. 80 MHz) STA that supports per-TXOP channel switching in a BSS with a Y-BW (e.g. 320 MHz) BSS operating channel. The STA that switches to one 80 MHz channel of the secondary 160 MHz channel receives and decodes the RU Index with PS160 equal to 0 and B0 of RU Allocation being 0. As defined by 802.11be, the RU Index with PS160 equal to 0 and B0 of RU Allocation being 0 means a RU in primary 80 MHz channel.

In a second example, the AP transmits the RU index to the STA in the secondary channel. After the STA has performed a DCS, as above, for a per-TXOP frame exchange in the non-primary channel, e.g., a secondary channel, the AP sends the RU Index on the secondary channel as if the RU is allocated to STAs that support the Y-BW. As an example, the STA that switches to the secondary 80 MHz channel of the 160 MHz BSS receives and decodes the RU Index with PS160 equal to 0 and B0 of RU Allocation being 1. This RU index indicates an RU in the secondary 80 MHz channel.

Consider an X-BW STA that supports per-TXOP channel switching in a BSS with a Y-BW BSS operating channel. It decodes the RU index that is covered by any X-BW channel in the BSS.

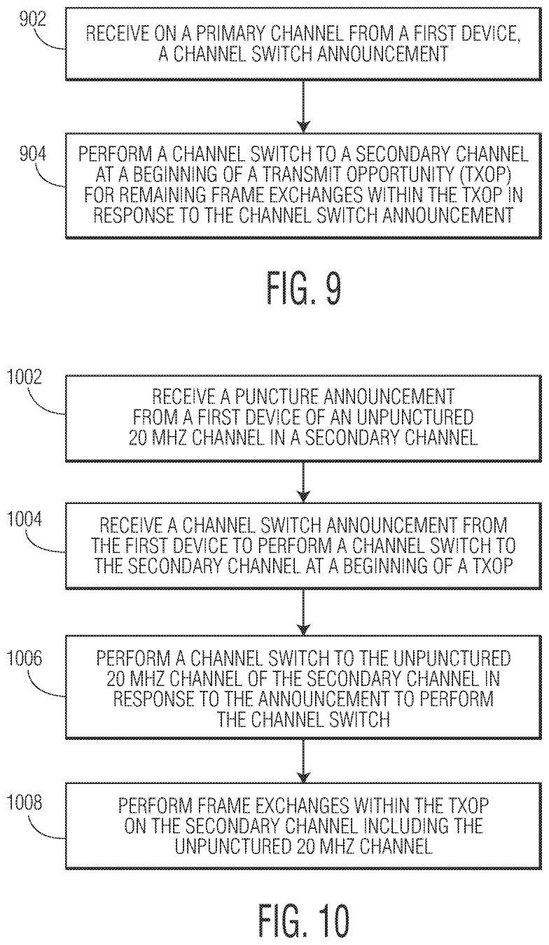

FIG. 9 is a process flow diagram of a dynamic switching method for wireless communications in accordance with an embodiment of the invention. The first wireless device announces a channel switch to a second wireless device, e.g., using a Trigger frame (e.g., BSRP Trigger etc.). At block 902, a channel switch announcement is received on a primary channel from the first device.

At block 904, a channel switch is performed to a secondary channel at the end of the PPDU carrying the Trigger frame soliciting the channel switch for remaining frame exchanges within the TXOP in response to the channel switch announcement.

While the method of FIG. 9 is conveyed from the perspective of a STA receiving announcement from an AP, there is a reciprocal method performed by the AP as is clear from the discussion and exampled provided above. From the perspective of the AP which has a BSS Operating Channel that includes a primary and a secondary channel, the AP, here the first wireless device transmits an announcement of the channel switch to the STA, here the second wireless device. After the channel switch is performed then the AP participates in the frame exchanges with the STA.

FIG. 10 is a process flow diagram of a dynamic channel switching method with an unpunctured channel for wireless communication in accordance with an embodiment of the invention. At 1002, a puncture announcement is received from a first device of an unpunctured 20 MHz channel in a primary channel only in the initial Trigger frame or in both the primary channel or secondary channel. At 1004, a channel switch announcement is received from the first device to perform a channel switch to the secondary channel. The channel switch announcement may come at a beginning of a TXOP and may be carried in the same frame as the puncture announcement, e.g., a Trigger frame (MU-RTS or BSRP Trigger).

At 1006, a channel switch to the unpunctured 20 MHz channel of the secondary channel is performed in response to the announcement to perform the channel switch. At 1008, frame exchanges are performed within the TXOP on the secondary channel including the unpunctured 20 MHz channel.

From the perspective of the AP, it sends a puncture announcement of an unpunctured 20 MHz channel and a channel switch announcement to the STA for the STA to switch to the unpunctured secondary channel. The AP then performs frame exchanges with the STA on the secondary channel including through the unpunctured 20 MHz channel.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless communication device comprising:
a transceiver configured to receive on a primary channel from a first device, a channel switch announcement from the first device; and
a controller configured to perform a channel switch to a secondary channel at a beginning of a transmit opportunity (TXOP) for remaining frame exchanges within the TXOP in response to the channel switch announcement.

2. The wireless communication device of claim 1, wherein the dynamic channel puncture that is different from the AP's static channel puncture is not allowed.

3. The wireless communication device of claim 1, wherein the channel switch announcement includes a puncture announcement of unpunctured 20 MHz channels of the secondary channels,
the transceiver configured to switch to the unpunctured 20 MHz channel of the secondary channels.

4. The wireless communication device of claim 3, wherein an unpunctured 20 MHz channel announced in the Trigger frame will not be punctured in the following frame exchanges of the TXOP and the controller of the second device is configured to decode a basic Trigger frame or frames in DL MU PPDU through the unpunctured 20 MHz channel.

5. The wireless communication device of claim 3, wherein the puncture announcement comprises an announcement of a dummy primary 20 MHz channel of the secondary channel that is not punctured, and the controller of the second device is configured to decode a basic Trigger frame or frames in DL MU PPDU through the dummy primary 20 MHz channel.

6. The wireless communication device of claim 3, wherein the unpunctured 20 MHz channel is within the secondary channels.

7. The wireless communication device of claim 3, wherein the puncture announcement comprises dynamic channel puncture information for punctured 20 MHz channels of the secondary channel.

8. The wireless communication device of claim 3, the transceiver configured to receive a control frame that includes the puncture announcement and the channel switch announcement.

9. The wireless communication device of claim 3, the transceiver configured to perform a frame exchange with the first device using the unpunctured 20 MHz channel.

10. The wireless communication device of claim 1:
wherein the transceiver is configured to receive a PPDU from the first device or the other devices associated with the first device, including a bandwidth (BW) and the duration information of the intra-BSS TXOP where the duration information is used to update the intra-BSS NAV timer at the second device, to receive an inter-BSS PPDU of an inter-BSS TXOP from a different BSS including a BW and the duration information of the TXOP where the duration information and the BW are used to update the basic NAV Timer, to receive an announcement from the first device to perform a channel switch to the secondary channel(s) at a beginning of a transmit opportunity (TXOP); and
wherein the controller is configured to perform a channel switch to the secondary channel(s) if the CCA checking indicates the medium idle where CCA checking includes (1) the PHY CCA within the SIFS after the received soliciting Trigger frame to announce the channel switch and (2) the virtual CCA checking by checking the BW of the basic NAV timer and the remaining time of the OBSS TXOP indicated by the basic NAV timer, and sending a responding PPDU if both the PHY CCA and virtual CCA indicate the switched secondary channel(s).

11. The wireless communication device of claim 10, wherein the controller of the second device is configured to maintain bandwidth information in the basic NAV timer of the second device.

12. The wireless communication device of claim 10, wherein when the BW of the inter-BSS PPDU is greater than the BW of basic NAV timer, the controller of second device updates the BW of the basic NAV timer.

13. The wireless communication device of claim 12, wherein the transceiver is configured to receive a soliciting Trigger frame including a request from the first device to perform a clear channel assessment (CCA) before preforming a frame transmission.

14. The wireless communication device of claim 1, wherein the transceiver is configured to perform a frame exchange with the first device during the TXOP using the basic NAV timer.

15. The wireless communication device of claim 1, wherein the remaining frame exchanges cover the primary channel.

17. The wireless communication device of claim 1, the transceiver configured to receive a resource unit (RU) Index for the secondary channel from the first device in the secondary channel after performing the channel switch where the RU Index is coded per the PPDU BW.

18. A method comprising:
receiving on a primary channel from a first device, a channel switch announcement from the first device; and
performing a channel switch to a secondary channel at a beginning of a transmit opportunity (TXOP) for remaining frame exchanges within the TXOP in response to the channel switch announcement.

19. The method of claim 18, wherein the channel switch announcement includes a puncture announcement of an unpunctured 20 MHz channel in the secondary channel, the method comprising switching to the unpunctured 20 MHz channel of the secondary channel.

20. A method of receiving frames from a first device at a second device associated with the first device, the method comprising:
receiving on a primary channel from a first device, a channel switch announcement from the first device; and
performing a channel switch to a secondary channel at a beginning of a transmit opportunity (TXOP) for remaining frame exchanges within the TXOP in response to the channel switch announcement;
receiving a resource unit index on the secondary channel after performing the channel switch; and
decoding the resource unit index for frame exchanges in the secondary channel.
